(19) United States
(12) Patent Application Publication
(10) Pub. No.: US 2003/0088582 A1
(43) Pub. Date: May 8, 2003

(54) Visual history multi-media database software

(76) Inventor: J. Robert Pflug, Auburn, NY (US)

Correspondence Address: Blackmon IPS & Law Office, 2101 Crystal Plaza Arcade PMB#289, Arlington, VA, 22202, US

(21) Appl. No.: 10/188,842

(22) Filed: Jul. 5, 2002

Related U.S. Application Data
(60) Provisional application No. 60/302,650, filed on Jul. 5, 2001.

(51) Int. Cl. G06F 17/00; G06F 17/30

(52) U.S. Cl. 707/104.1; 707/10

(57) ABSTRACT

A virtual library of photographs stored in electronic pages, volumes (“album”), and bookshelves (“collections”) for easy retrieval. An extended multimedia database is created to provide a method of distinguishing and sorting consumer photographs in a meaningful manner conducive to network sharing by interested groups. By providing a graphic representation of the photograph, motion picture, audio file (wav, mp3, etc.), document, or other multimedia file stored, new and useful means of recalling and sorting the media files (hereinafter referred to exemplarily as “photographs”) are obtained. In an initial method, a virtual library of photographs is provided having a bookshelf holding individual volumes of photographs containing multiple pages of photographs. This virtual library allows the photographs to be stored on pages, volumes, and bookshelves sorted according to user criteria. The user can then pull a particular volume of photographs from the shelf to access a particular cross-section of the stored photographs.

This application is a claims priority to earlier filed provisional Application Serial No. 60/302,650 filed Jul. 5, 2001, entitled Visual Histo Multi-Media Database Software which is hereby incorporated by reference.

### BACKGROUND OF THE INVENTION

A. Field Of The Invention

The present invention relates to a method of storing multi-media such as photographs in a distributed database for networked retrieval by different sort or collection patterns represented by various graphic icons.

B. Description Of The Prior Art

Databases have been in use on computers for many years. Data can be collected, stored, sorted and retrieved using a variety of sorting patterns and reports. The data is usually numbers, words, text strings or some combination there of which can be represent by an alphanumeric field of finite length. Common examples database fields include sales data, description of the sales, sales person and sales amounts, costs of sales, etc. The current databases are sufficient to handle this alphanumeric Information and can sort the data alphabetically, numerically, etc. However none of the databases to date can effectively store, index and retrieve large volumes of multi-media information or, more specifically, “glimpses of life” across place and time.

None of the current databases provides adequate ways of distinguishing and sorting consumer photographs in a meaningful manner conducive to network sharing by interested groups. Alphanumeric databases and the like by comparing ASCII codes or the names of the photographs, which provides little useful assistance to a person collecting thousands of photographs depicting his life. Sorting the photographs by date of entry into the computer likewise provides little assistance.

Therefore, the current invention fills a void left by the alphanumeric databases and incomplete multimedia databases. By providing a graphic representation of the photograph, motion picture, audio file (wav, mp3, etc.), document, or other multimedia file stored, new and useful means of recalling and sorting the media files (hereinafter referred to exemplarily as “photographs”) are obtained. In an initial method, a virtual library of photographs is provided having a bookshelf holding individual volumes of photographs containing multiple pages of photographs. This virtual library allows the photographs to be stored on pages, volumes, and bookshelves sorted according to user criteria. The user can then pull a particular volume of photographs from the shelf to access a particular cross-section of the stored photographs.

None of the above inventions and patents, taken either singly or in combination, is seen to describe the instant invention as claimed.

### SUMMARY OF THE INVENTION

Accordingly, it is a principal object of the invention to provide a virtual library of photographs stored in electronic pages, volumes (“album”), and bookshelves “collections”) for easy retrieval

It is another object of the invention to provide means of sorting the photographs into volumes and pages according to user criteria

It is a further object of the invention to a method of annotating photographs, pages or volumes to organize information about the photographs, pages or volumes such as the identity of associated persons, places, dates, albums, owner, and original file location by providing tags therefor

It is an object of the invention to provide peer-to-peer distribution of multimedia over a network such as an intranet or internet which is inexpensive to organize and share photographs between relatives or other groups.

It is yet another object to provide a virtual landscape for exploring and sharing files between peers over the internet or other networks.

Still another object of the invention is to associate diverse multi-media presentations with particular photographs, pages or albums such as sound bites, slide shows, graphic labels, or other presentation material.

It is an object of the invention to provide improved elements and arrangements thereof in an apparatus for the purposes described which is inexpensive, dependable and fully effective in accomplishing its intended purposes.

It is another object of the invention to provide a safe storage for the images within the albums by having the photographs reproduced and stored in digital form in a weatherproof area as a backup for the original photographs which are vulnerable to damage by fire water heat and light

It is yet another object of the invention to provide an organized historical reference or an entertainment source during later retrieval.

These and other objects of the present invention will become readily apparent upon further review of the following specification and drawings.

### BRIEF DESCRIPTION OF THE DRAWINGS

FIG. 1 is a diagrammatic view of the virtual library bookshelf screen according to the present invention.

FIG. 2 is a diagrammatic view of the collections screen according to the present invention

FIG. 3 is a diagrammatic view of a page of a collection according to the present invention

FIG. 4 is a diagrammatic view of an image having image labels according to the present invention.

FIG. 5 is a diagrammatic view of a slide show management screen according to the present invention.

FIG. 6 is a diagrammatic view of a report form screen according to the present invention

FIG. 7 is a diagrammatic view of a drop down list according to the present invention.

FIG. 8 is a diagrammatic view of a filter having text selection according to the present invention

FIG. 9 is a diagrammatic view of a virtual library according to the present invention.

Similar reference characters denote corresponding features consistently throughout the attached drawings. The present invention

### DETAILED DESCRIPTION OF THE PREFERRED EMBODIMENT(s)

The present invention relates to an improved virtual library as a graphical database for storing photographs and other multi-media information for further retrieval and sorting

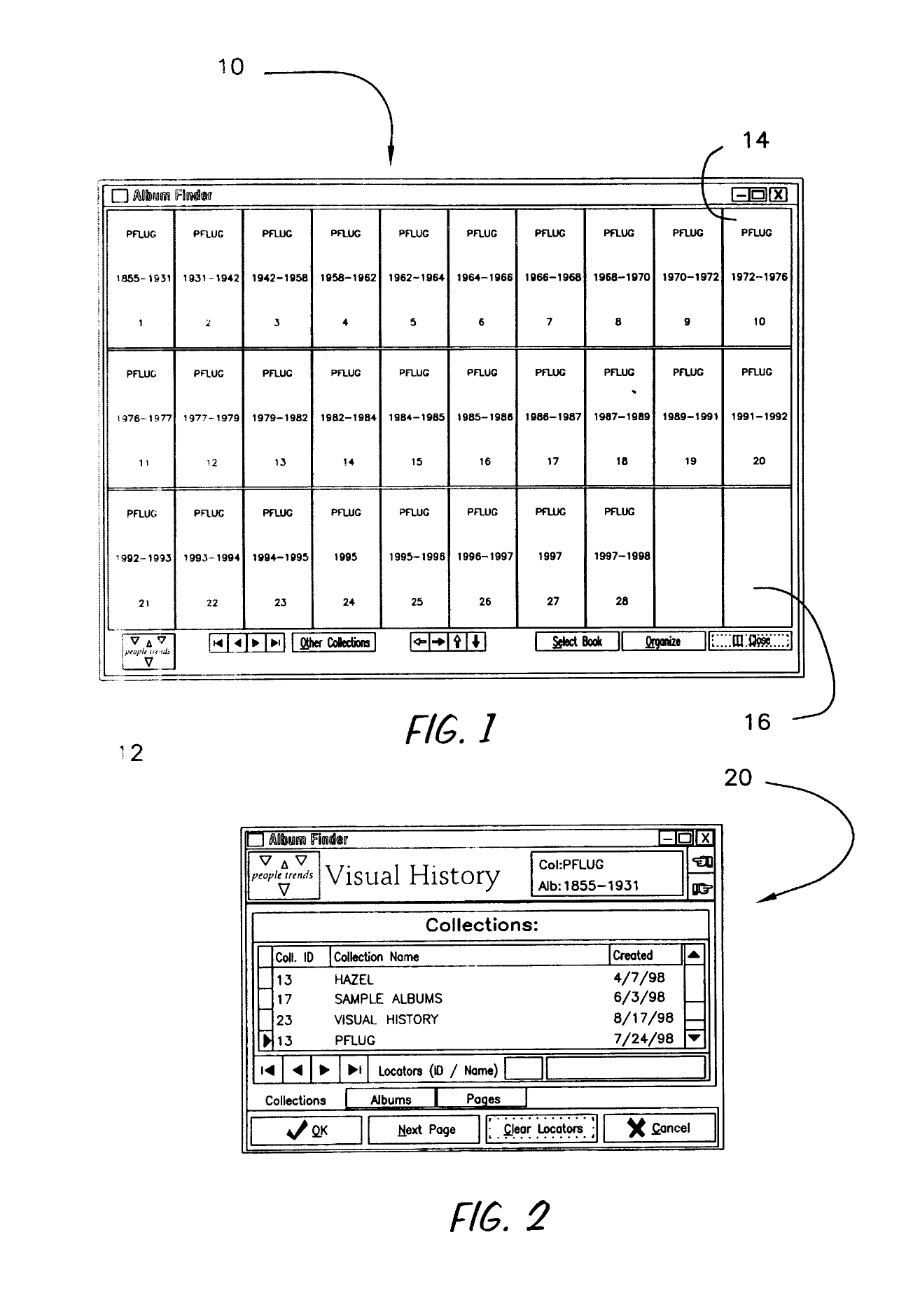

A virtual library 10 is shown in FIG. 1 for storing, accessing and sorting photographs and other multi-media in a graphic based database manager. A first collection 12 is shown graphically as a number of volumes 14 (“books” or “albums”) on a virtual bookshelf 16. The particular collection shown has 28 volumes with two empty spaces on the bookshelf. The collection is shown as being sorted by calendar dates ranges, but one skilled in the art would recognize that other sorting means could be used such as family generations, content, subject matter, topic, location, when, where, who shooter, custodian etc.

Diverse bookshelves can be displayed having different collections thereon by selecting the “other collections” button 18 to display the collections screen 20 of FIG. 2. A user wishing to display a collection having a different set of pictures (“photographs”) could select from the collections shown on the collections screen as shown. A new collection could also be started by entering a new collection as will be discussed later.

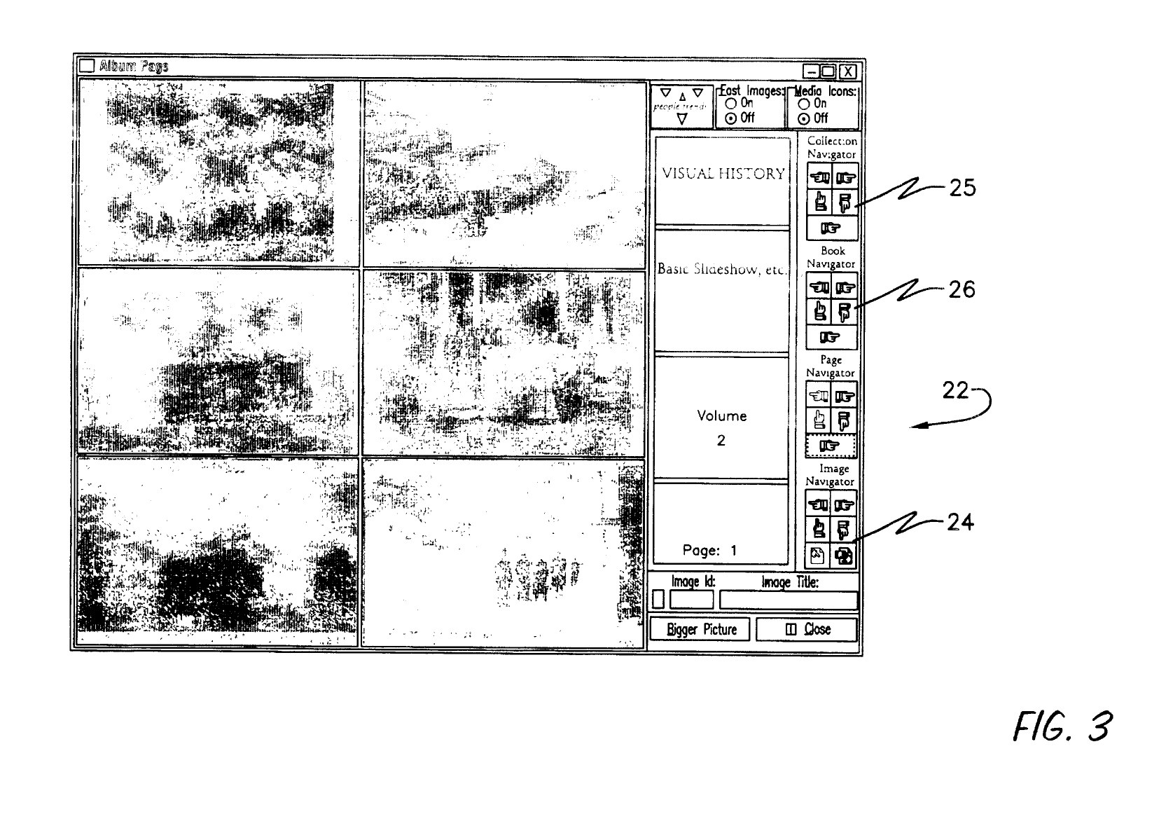

Once the collection has been selected, a particular volume 14 (FIG. 1) can be selected by clicking on the graphic of the desired album. The first page 22 (FIG. 3) can then be displayed showing photographs associated with the particular volume. The user can move forward and backwards through the pages by selecting appropriate keys (not shown) or graphic indicators 24 to flip one or more pages. Indicators may also be provided to advance or go back one or more volumes 26 or one or more collections 28 as required.

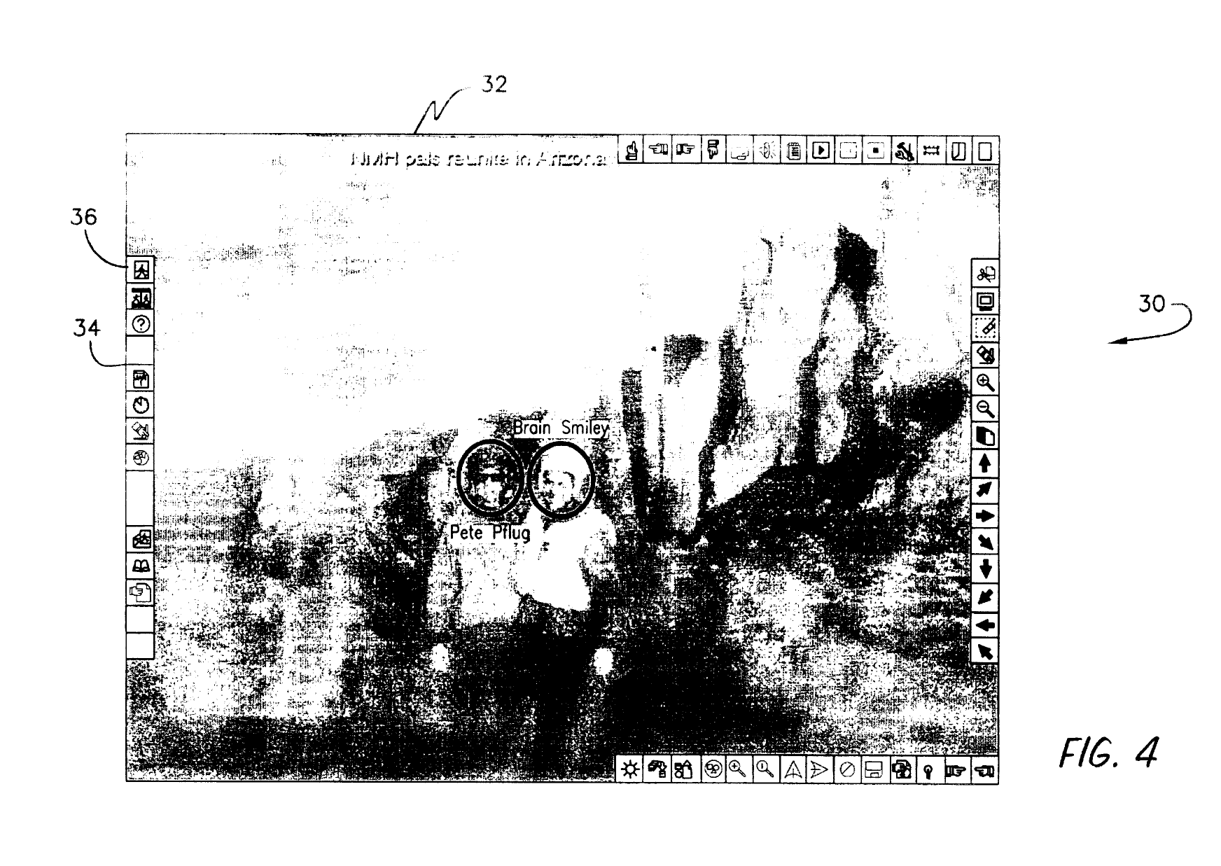

Each photograph can have additional information associated with the photograph. As shown in FIG. 4, one such type of information is labels (“tags”) associated with elements in the photograph 30. Here the people “Pete Pflug” and “Brian Smiley” have been identified in the photograph with a pointer in the shape of a circle identifying the element associated with the label. One skilled in the art would also recognize that other elements could also be named or identified, including but not limited to fauna, flora, geologic formations (e.g., “mountains), inanimate objects (e.g. “cars” or “buildings”). One would also appreciate that the pointer could be a line, an arrow, a box or other graphic designator.

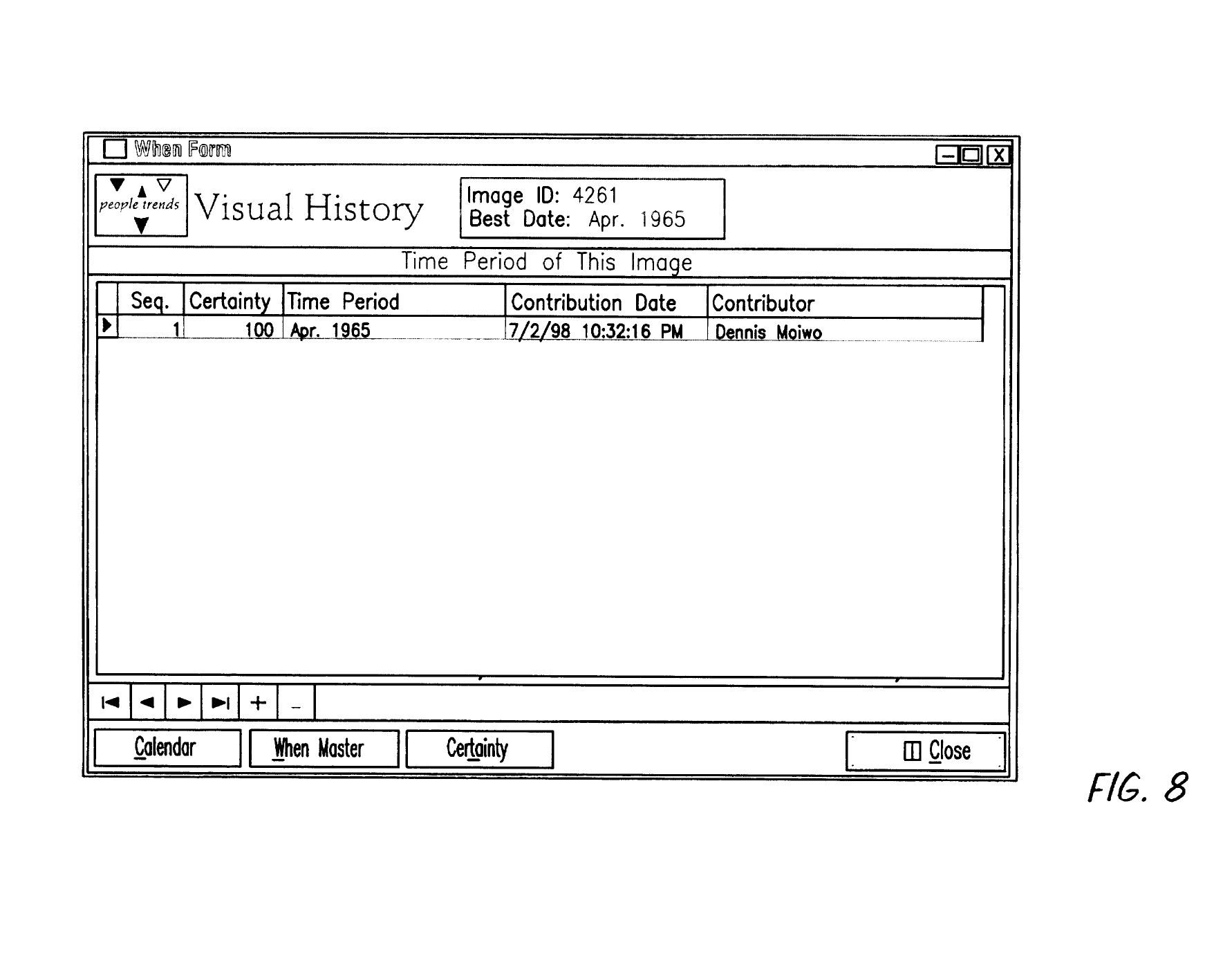

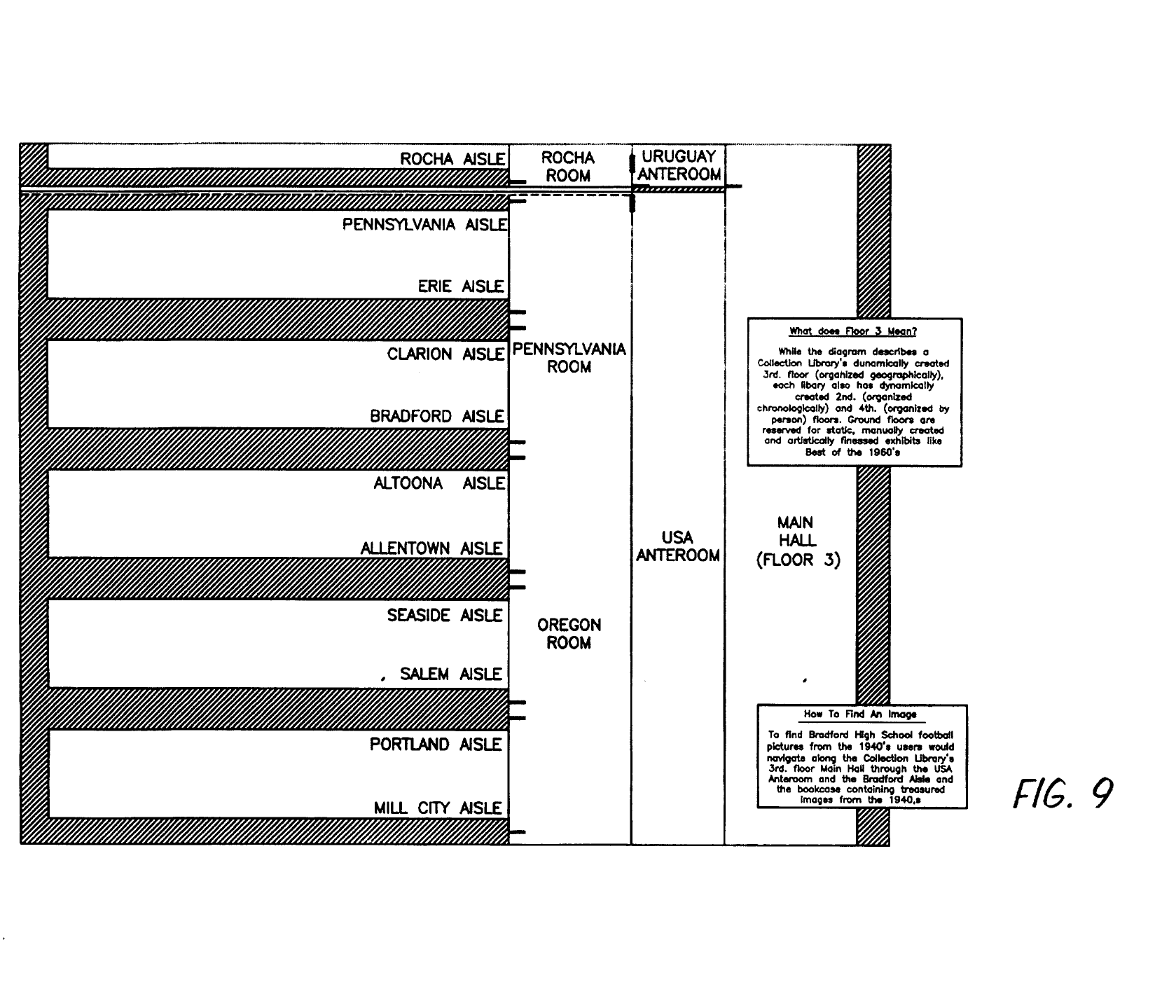

Additional label information can also be associated with the photograph. FIG. 2 shows a title 32 of “NMH pals reunite in Arizona” for the photograph. Preferably additional information is also provided to help identify the photograph such as the date of the photograph, and other tags Other tags may be available to help group photographs together such as topical indices, slideshow indices, or other miscellaneous indices which will be described later to provide filters which are used to display groups of images in smaller groupings. The tags may be typed in as text information in provided screens (See FIG. 8), but are preferably selected from an expandable list of options from a database field. For example, a “person” field may contain a list of all of the people in the photographs with means to enter new people into the field as needed. The text for a tag identifying a person in a photograph can then be easily selected from a drop down list of people (See FIG. 7) in the people field rather than having to type the person's name in a text field.

Several other tags for the photographs will also be included such as the collection(s) and volume(s) to which the photograph belongs. A location tag for where the image file is located will also be associated with the photograph, since the database will preferably manipulate a data field containing a pointer to the image file and not the image file itself to reduce calculation times. The picture may also have security, ownership and privileges designators to determine who may alter, erase, or re-label the image.

Tags and labels can be provided to the picture by means of a graphical menus as shown in FIG. 4 to select the type of pointer which will indicate the portion of the photograph the label is associated with and text boxes for entering the tag information. Additional graphic tools 34 are used as shown on the left portion of FIG. 4 to add in time information (“date”) information.

In addition to still images such as photographs, other multimedia may be displayed. A movie such as an MPEG or AVI or MOV formatted digital movie can be displayed. Preferably a still frame from the movie is shown as an image with a designator such as a movie reel icon 36 indicating that the photograph is a multi-media image. By clicking on the movie reel icon or on the still image, the movie can be initiated to show the multimedia presentation, in this case a short movie. Since the movie is preferably digital, individual frames of the movie can be tagged or labeled in a manner described above with reference to a photograph. Means may be provided to jump through the tags of the movie or to stop the movie at the particular tags as necessary

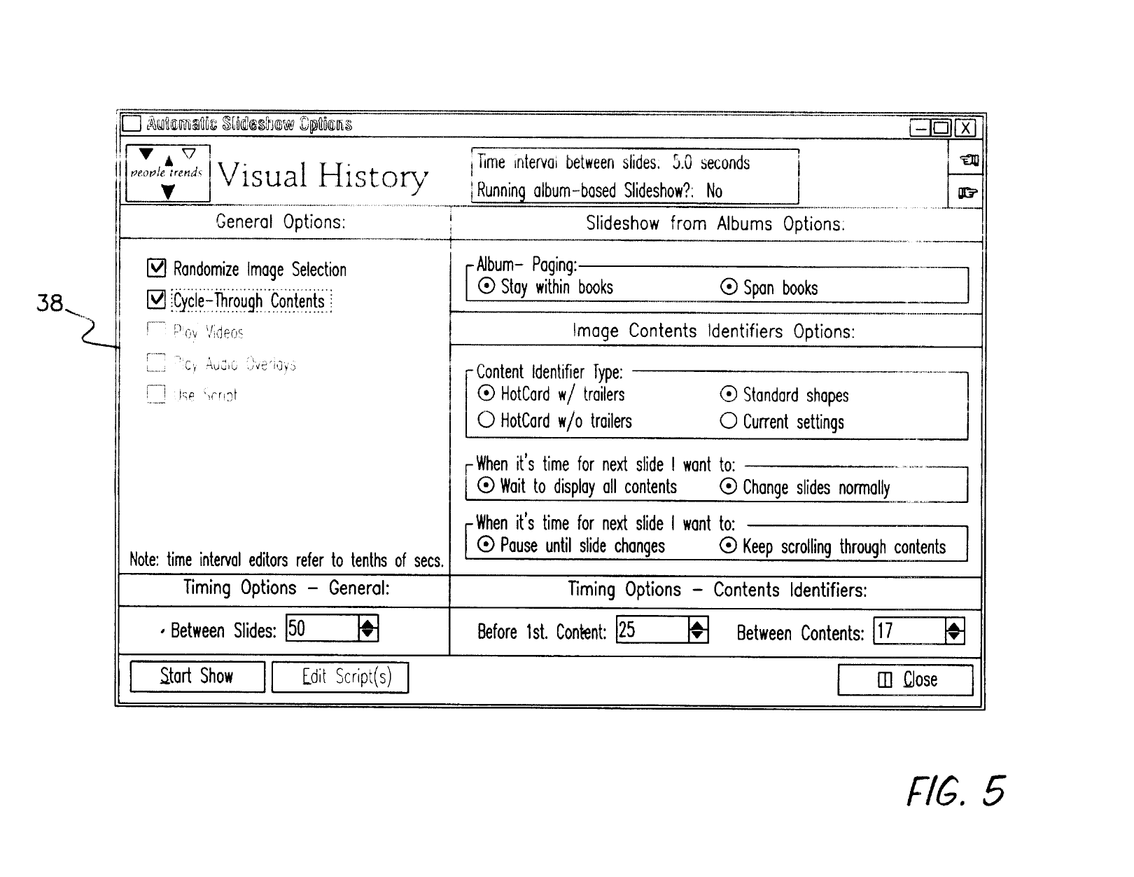

The method in which the photographs are presented to the user can be changed. A “sideshow” can be presented to the user in a sequence selected by the user or can be shown in random order. FIG. 5 shows a slide show option screen. Buttons 38 allow the user to select a random order display and whether to show all the pictures only once or restart the sequence at the end (“cycle-through” or “rollover”). A selection screen can also be provided to designate the images to be included in the slide show Particular collections or volumes can be selected as the content for the slide show. Additionally, the textual information entered as tags for the images, such as the people shown in the photographs or time periods can be used as filters to further select the group of photos to be shown. For example, all photographs from the “Pflug” collection showing “Brian Smiley” can be selected. The slideshow can then sequentially show all the images meeting the selected criteria. The collections made for the slideshow can be saved for later viewing, or may be placed in a book for selection later The book can be labeled “Smiley Slideshow” for example, for later easy recall.

Entry of new photographs or the initial photographs can take many forms. One skilled in the art would recognize that many forms of digitizing an image or multi-media presentation are possible. Digital cameras and video-cameras are available which directly digitize images into computer readable form. Also, camera stores or other stores having developing capabilities now often provide compact discs (“CDs”) with digital images of the photographs along with printouts of the photos. Other methods of scanning photographs and digitizing images are known and can be used to provide a digital image.

Once the photograph is in digital format, the photograph can be entered into the present database. The raw images, i.e. those that have not been tagged, are preferably grouped to one directory (with or without subdirectories) or a CD. The images can then be added to the database as a group or can be individually selected to add to the database. A new collection can be opened to receive the images or an existing collection can be opened to receive the new images. The images having no tags can be tagged as a group as they are entered or can later be individually tagged, or additionally tags can be added to photographs that were group tagged. This is especially helpful if the user is adding a group of pictures taken at a single event such as a birthday party and then can later identify the persons in individual pictures by adding additional tags.

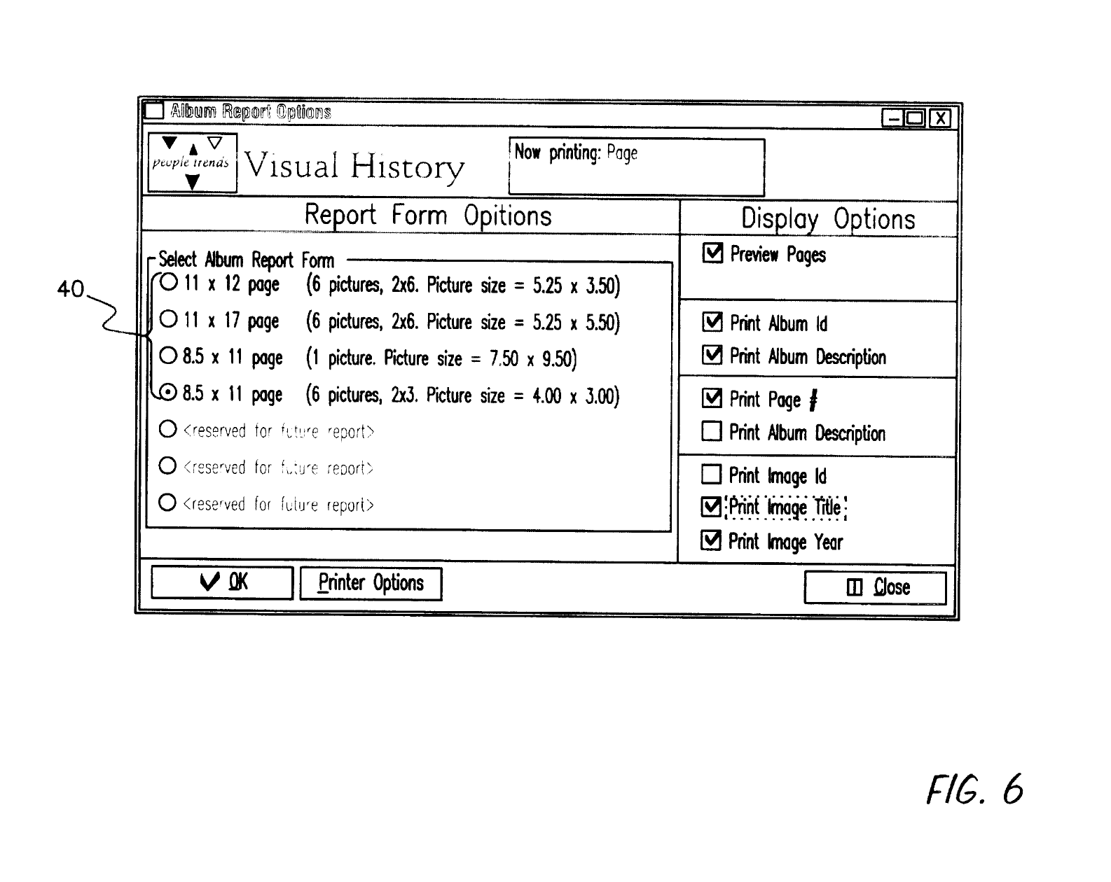

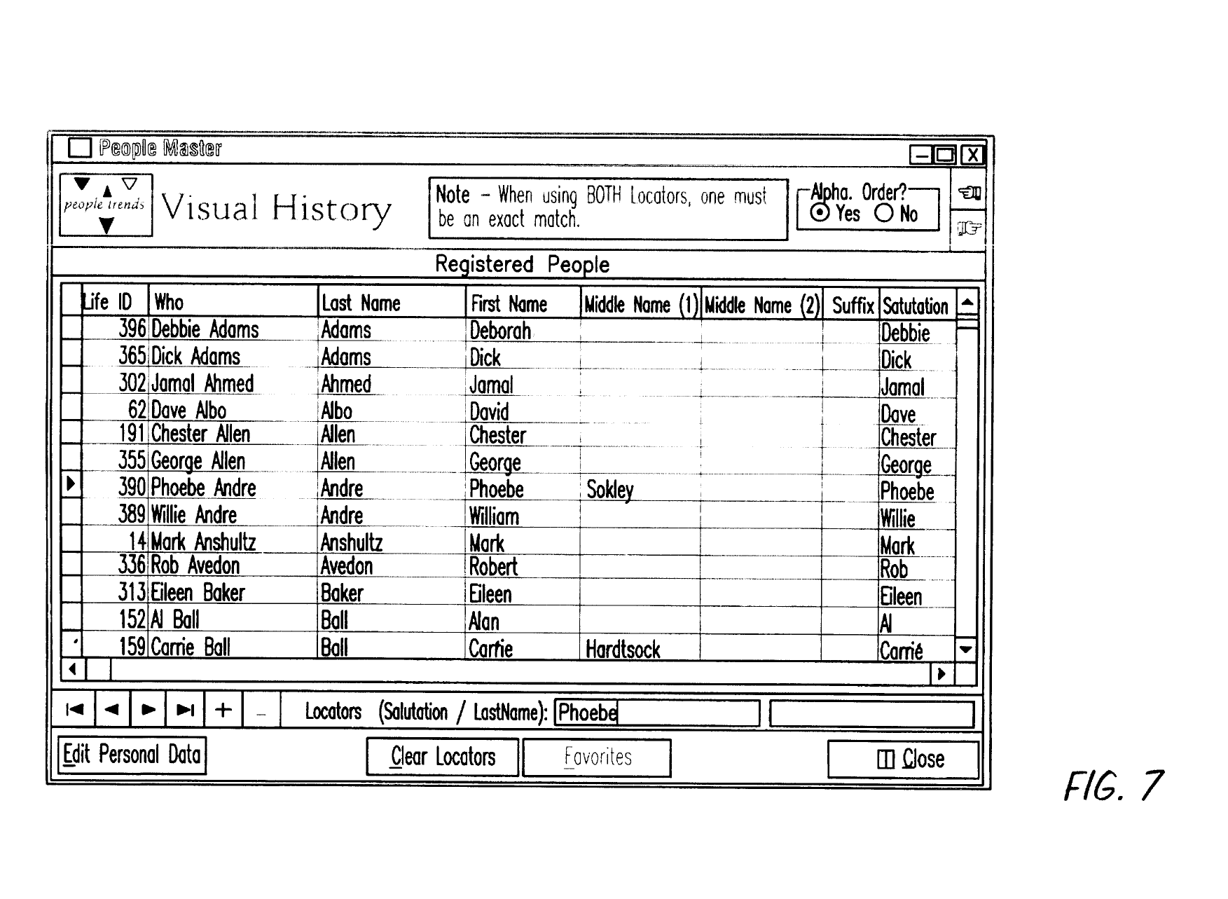

Photographs that are scanned in can be manipulated in other ways to ensure proper presentation. FIG. 6 shows a screen for setting individual pages of a book. Similar to actual physical photo-albums, photographs of different sizes can be placed on the virtual pages of the database. Buttons 40 allow pages of a book to be sized to receive photographs of different sizes. As the photographs are added to the books, they are displayed at the size allocated for the picture. For photographs not originally scanned in at this size, either the photograph will be shrunk or expanded to fit the display size or only a portion of the photograph will be shown. The display size can be changed to provide adequate display size for the photograph if the automatic display is unsatisfactory

Once the collection has been completed, it is contemplated that the photographs can be shared over the internet or similar network (hereinafter mentioned as the “internet” or the “network” to contemplate either form).

In the same way that the viewer described above shows a virtual library having bookshelves and albums/books containing photographs, a user can explore other virtual libraries outside his computer over a network through a virtual landscape.

A user wanting to view only photographs on his own computer will purchase/license a low level version of the software to organize and view his images on the computer. To search beyond his own computer, a user would upgrade to a image searcher module of the software.

In light of limitations on individual servers and hosts, greater efficiencies and speeds can be brought about by using peer to peer technologies, where a user directly receives information from a second user instead of from a main server. The main server is still necessary to point the first user to the second user, and perhaps to maintain a database or index of files or users viewable by the users.

Unlike earlier systems, which provided an index of all current users and all current files by all of the users in a table viewable by any user, a more focused server role is anticipated by the present invention. A main server will maintain a database of users registered with the site. In a manner known, the server will allow additional users to register (or “subscribe”) or allow users to unregister (“unsubscribe”) to provide a dynamic list of users. The site will also provide means for allowing the tracking of which users are currently on-line or in communication with the server.

A particular user will not necessarily have access to all of the files of the other users or even be able to access a list of the other users. Instead, since photographs are more likely to be of interest to only a limited pool of people, registration of a particular user with particular groups is anticipated. A user may register with a group containing only relatives, or friends, or schoolmates or other groups of interest. Or a user may register with publicly available groups such as real-estate brokers or art dealers or other public interest or commercial groups.

A user having a search module can then be directed by the main server to a limited number of other virtual libraries on the virtual landscape. The main server continually or sporadically polls the users (“seeker”) to determine which libraries are “open” (“on-line”) to be viewed. If a library is “open” and the user is registered, then the user can enter the library of another user (“presenter”) to retrieve photographs or make inquiries. As shown in FIG. 9, an inquiry menu search is shown as virtual library, which is shown by example only and the invention is not limited to the layout of the particular library.

The second floor could contain a chronological index of the photos, while the third floor contains a geographic index. The fourth floor could contain an alphabetic index of such information as the last names of shooters or subjects. The first floor could contain the base information on the photographs such as the image id useful for indexing the photographs by the date of contribution, etc.

The seeker would then by way of example proceed to the third floor to seek photographs on a particular geographic subject, such as the presenter's trips to Pennsylvania. After selecting an anteroom of USA and proceeding to the Pennsylvania room, the seeker could select the “Bradford Aisle” and a bookshelf containing 19th century photographs collections. In this way, instead of following a cumbersome text menu, the seeker follows a logical menu presented as a virtual trip to the library. Once in the proper place, thumbnails of pictures of the particular subject can be downloaded.

Depending on the speed of systems involved and the progress of the internet, preferably only small thumbnails or small photograph index files of the actual photographs are automatically downloaded to the seeker's computer. By double clicking on a thumbnail print, the full photograph can be downloaded. The well known use of thumbnail photos saves both time and bandwith and reduces unnecessarily filling the cache of the seeker's computer with unnecessary information. However, one skilled in the art would recognize that the photographs themselves could be downloaded without departing from the scope of the invention.

In a hybrid of the invention, the library could be held on the server instead of a client's computer. The library can actually represent the combined photographs of several members of a group such as a family. A library floor could be used to allow individuals or smaller subgroups within the group to be searched. In this case, the server could poll the users' computer to maintain an index of photographs compiled into a single virtual library. Once the seeker has pulled a single collection, the actual thumbnails or perhaps only the photographs could be transferred from the presenter's computer instead of the entire indices. In this way division of bandwith between the clients and servers can be utilized to provide easily accessible information while maximizing the speed of access to the information.

It is further contemplated that the invention will provide for a service industry of scanning photographs Into a usable form for the presenter. The virtual library software would preferably contain a program for scanning a directory or series of directories and their subdirectories for images and automatically loading the photographs and associated information. The information may be as simple as the file date, or in a similar way that MP3s have indexed information, it is contemplated that the image files may contain indexed information which is also recognized by the program. Likewise the program may accept images or other files exported from or converted from other programs along with additional information provided through those programs.

Unlike peer-to-peer programs such as that used by NAPSTER, image files are not likely to be searched by great numbers of people. It is contemplated that groups with like interests, be they family, school, geographic, religious, or commercial interests, small groups of users will want to register with each other. Each group may have the ability to limit what other users can see their groups, members or images. Other groups may prefer open membership or guest privileges, especially commercial groups such as real-estate brokers showing images of houses for sale, art dealers, or other similar commercial or private enterprises. Baseball card collectors or auctioneers may want the ability to organize and display pictures of broader interest using the disclosed invention.

It is to be understood that the present invention is not limited to the sole embodiment described above, but encompasses any and all embodiments within the scope of the following claims.

I claim:

1. An electronic organizer for multimedia files having the form of a virtual library.

2. The organizer of claim 1, wherein the multimedia files are further organized in the form of virtual books in a virtual library.
